(19) United States
(12) Patent Application Publication
(10) Pub. No.: US 2026/0309648 A1
(43) Pub. Date: Oct. 8, 2026

(54) X-RAY INSPECTION APPARATUS

(71) Applicant: ANRITSU CORPORATION, Kanagawa (JP)

(72) Inventors: Takashi KANAI, Kanagawa (JP); Tatsuki KOMATSUBARA, Kanagawa (JP); Naoya SAITO, Kanagawa (JP)

(21) Appl. No.: 19/630,547

(22) Filed: Mar. 27, 2026

(30) Foreign Application Priority Data
Apr. 3, 2025 (JP) 2025-061845

(51) Int. Cl. G01N 23/04; G01N 23/083

(52) U.S. Cl. CPC G01N 23/04; G01N 23/083; G01N 2223/204; G01N 2223/313; G01N 2223/316; G01N 2223/401; G01N 2223/50; G01N 2223/643

(57) ABSTRACT

An X-ray inspection apparatus includes: an irradiation unit that irradiates an article with X-rays; a detection unit that detects the X-rays transmitted through the article; an image generation unit that generates an image corresponding to a detection result of the detection unit; and an inspection unit that inspects the article based on the image, in which the irradiation unit includes an X-ray generation source that outputs X-rays having a continuous spectrum, and a physical filter that removes a partial band of the X-rays output by the X-ray generation source to irradiate the article with resulting X-rays from which a partial band of the X-rays has been removed, and the detection unit detects, using a photon-counting method, the X-rays transmitted through the article, the X-rays being X-rays from which a band unnecessary for image generation in the image generation unit has been removed by the physical filter.

### TECHNICAL FIELD

The present invention relates to an X-ray inspection apparatus, and particularly to an X-ray inspection apparatus that irradiates a transported article with X-rays and inspects the article based on an X-ray transmission image.

### BACKGROUND ART

In an X-ray inspection apparatus using X-rays, in general, when X-rays are emitted onto an inspection object being transported within an inspection region and are transmitted through an article, an image detection signal is output from an X-ray detection unit that detects the X-rays on a transmission side, and the article is inspected using an X-ray inspection image generated based on the output signal.

In such an X-ray inspection apparatus, in order to prevent leakage of the X-rays to an outside of the apparatus, a collimator formed of an X-ray shielding material is disposed in a path of X-ray irradiation from an X-ray irradiation unit, and the collimator shapes the X-rays from the X-ray irradiation unit into a cone-shaped or fan-shaped beam, so that an irradiation region of the X-rays is not excessively wider than a detection area of the X-ray detection unit.

As a conventional X-ray inspection apparatus of this type, there is known an X-ray inspection apparatus including an article transport unit, an X-ray irradiation unit, a collimator, and an X-ray detection unit, and further including a temperature measurement unit that measures a temperature of an X-ray tube of the X-ray irradiation unit, a storage unit that stores position control data indicating a relationship between a focal point temperature and a focal point position movement amount of the X-ray tube, and a position control unit that moves at least one of the X-ray irradiation unit, the collimator, and an X-ray line sensor of the X-ray detection unit based on the temperature measured by the temperature measurement unit.

In this apparatus, the position control unit executes position control of moving at least one of the X-ray irradiation unit, the collimator, and the X-ray line sensor of the X-ray detection unit so as to cancel movement of a focal point position in position adjustment data corresponding to the temperature of the X-ray tube measured by the temperature measurement unit (for example, see Patent Document 1).

### Related art Document

### Patent Document

Patent Document 1 JP-A-2018-146554

### Disclosure of the Invention

### Problem that the Invention is to Solve

In the conventional X-ray inspection apparatus as described above, even when a target in the X-ray tube (X-ray generation source) of the X-ray irradiation unit thermally expands with an environmental temperature or an elapsed operation time and a target position moves from an initial position, displacement of a focal point position of the target corresponding to the temperature of the X-ray tube measured by the temperature measurement unit is substantially canceled based on the temperature of the X-ray tube by operating the position control unit. Therefore, a slit width of the collimator can be limited to a required width, and the X-ray output of the X-ray irradiation unit can be suppressed; thus, diffusion of the X-rays to both sides in a transport direction in which an article inlet and an article outlet are present can be effectively suppressed, and the leakage amount of the X-rays can be sufficiently reduced.

However, even when the X-ray irradiation region is optimized in this way, the X-rays emitted from the X-ray irradiation unit onto the article include a spectral band other than an X-ray intensity required for X-ray inspection. Therefore, it may be necessary to limit the X-ray output in order to sufficiently suppress the leakage amount of the X-rays.

In addition, when a photon-counting type X-ray detector is used, in a case where X-ray flux incident on the X-ray detector is high, a pile-up phenomenon is likely to occur in which measurement pulse signals output at close detection timings from a detection element array (sensor array) of the X-ray detector overlap each other to form a high-energy measurement pulse.

Therefore, when it is desired to generate a plurality of transmission image data having different X-ray transmission energies (higher and lower) based on the image detection signal from the X-ray detector and to perform difference processing on the plurality of transmission image data to generate differential image data in which an image influence due to a difference in material (transmittance) between the article and a foreign matter contained in the article is increased, thereby increasing foreign matter detection sensitivity, there is an unsolved problem that discrimination performance of the X-ray transmission energy deteriorates, so that highly accurate differential image data cannot be obtained, and the foreign matter detection accuracy cannot be sufficiently increased. Furthermore, there is a case where the X-ray output (dose) needs to be limited in order to prevent the energy discrimination performance from deteriorating.

Therefore, an object of the present invention is to provide an X-ray inspection apparatus that is excellent in discrimination performance of X-ray transmission energy even with a high dose of X-rays and that can sufficiently increase foreign matter detection accuracy.

### Means for solving the problem

As an example of an embodiment of the present invention, there is provided an X-ray inspection apparatus including: an X-ray irradiation unit that irradiates a transported article with X-rays; an X-ray detection unit that detects the X-rays transmitted through the article using a photon-counting method; an image generation unit that generates an X-ray image corresponding to a detection result of the X-ray detection unit; and an inspection processing unit that inspects the article based on the X-ray image, in which the X-ray irradiation unit includes an X-ray generation source that outputs white X-rays having a continuous spectrum, and a physical filter that removes a partial band of the white X-rays output by the X-ray generation source to irradiate the article with resulting X-rays from which a partial band of the white X-rays has been removed, the physical filter being provided between the X-ray generation source and the X-ray detection unit, and the X-ray detection unit detects, using the photon counting method, the X-rays transmitted through the article, the X-rays being X-rays from which a band unnecessary for image generation in the image generation unit has been removed by the physical filter.

With this configuration, among the X-rays emitted from the X-ray irradiation unit, X-rays in a spectral band unnecessary for inspection in the inspection processing unit, for example, X-rays in a low-energy band that are absorbed by the article and do not reach the X-ray detection unit, are prevented from being photon-counted even in a range where the X-rays are not transmitted through the article or in a thin portion of the article. Therefore, it is possible to effectively suppress an increase in X-ray flux incident on the X-ray detector, and to effectively suppress occurrence of pile-up.

As an example of the embodiment of the present invention, the physical filter may be replaceably provided in the vicinity of an irradiation port of the X-ray irradiation unit.

In this case, since the physical filter is replaceable in the vicinity of the irradiation port of the X-ray irradiation unit, it is possible to prevent X-rays in an unnecessary spectral band from being emitted from the X-ray irradiation unit, and to replace the physical filter according to the article.

As an example of the embodiment of the present invention, the X-ray inspection apparatus may further include: non-inspection band determination means for determining, as an unnecessary spectrum, a partial band of the white X-rays that is unnecessary for inspection of the article in the inspection processing unit; and filter setting means for switchably setting a physical filter corresponding to the unnecessary spectrum according to a determination result of the non-inspection band determination means.

In this case, when the non-inspection band determination means determines a partial band that is unnecessary for the inspection of the article as the unnecessary spectrum, the physical filter corresponding to the unnecessary spectrum is set to be switchable according to the determination result.

As an example of the embodiment of the present invention, the non-inspection band determination means may determine, as the unnecessary spectrum, a band lower than an energy threshold at which the number of count values determined as the unnecessary spectrum is maximized when an energy threshold for determining the unnecessary spectrum is changed to a plurality of different values within a predetermined variable range in a state where X-rays emitted from the X-ray irradiation unit and transmitted through a non-defective article are detected by the X-ray detection unit.

In this case, since the energy threshold for determining the unnecessary spectrum is a threshold that most suppresses influence of the article, it is suitable for foreign matter detection.

As an example of the embodiment of the present invention, threshold storage means for storing the energy threshold for each product type of the article may be provided, the non-inspection band determination means may select and set any one of the energy thresholds stored in the threshold storage means according to the product type of the article, and the filter setting means may select and set a physical filter corresponding to any one of the energy thresholds selected and set by the non-inspection band determination means according to the product type of the article.

In this case, it is possible to select and set the physical filter corresponding to the unnecessary spectrum according to the product type of the article.

As an example of the embodiment of the present invention, the filter setting means may have, as the physical filter, a plurality of filter elements having different materials and thicknesses in an X-ray transmission direction, the plurality of filter elements being displaceable in a predetermined direction, and may be configured to enable replacement, in the vicinity of an irradiation port of the X-ray irradiation unit, of any one of the plurality of filter elements according to the product type of the article.

In this case, since any one of the plurality of filter elements can be replaced in the vicinity of the irradiation port of the X-ray irradiation unit according to the product type of the article, it is possible to effectively suppress an increase in X-ray flux incident on the X-ray detector by cutting a partial band that is an unnecessary spectrum regardless of the product type of the article, and it is possible to effectively suppress occurrence of pile-up during photon counting.

### Advantage of the Invention

According to the present invention, it is possible to provide an X-ray inspection apparatus that is excellent in discrimination performance of X-ray transmission energy even with a high dose of X-rays and that can sufficiently increase foreign matter detection accuracy.

### BRIEF DESCRIPTION OF THE DRAWINGS

FIG. 1 is a schematic configuration diagram of an X-ray inspection apparatus according to an embodiment of the present invention.

FIG. 2 is a schematic configuration diagram of a photon-counting type X-ray detection unit in the X-ray inspection apparatus according to the first embodiment of the present invention.

FIGS. 3A and 3B are schematic arrangement explanatory diagrams of a collimator and a physical filter provided in the vicinity of an irradiation port of an X-ray irradiation unit in the X-ray inspection apparatus according to the first embodiment of the present invention, in which FIG. 3A is a top view of the collimator and the physical filter in the arrangement state, and FIG. 3B is a front cross-sectional view of the collimator and the physical filter in the arrangement state.

FIG. 4A is a graph showing, including a pulse signal in which a pile-up phenomenon occurs, a signal level waveform of a pulse signal having a wave height corresponding to X-ray energy during photon-counting type X-ray detection in a non-inserted state of the physical filter in the X-ray inspection apparatus according to the first embodiment of the present invention, and FIG. 4B is a graph showing a signal level waveform of a pulse signal having a wave height corresponding to X-ray energy during photon-counting type X-ray detection in a state where the physical filter is inserted in the vicinity of the irradiation port of the X-ray irradiation unit, in each of which a vertical axis indicates a pulse signal level and a horizontal axis indicates a scan time.

FIG. 5 is a schematic configuration diagram of an X-ray inspection apparatus according to a second embodiment of the present invention.

FIG. 6 is a perspective view of a physical filter in the X-ray inspection apparatus according to the second embodiment of the present invention, showing a slide-type physical filter unit in which a plurality of types of physical filters are arranged adjacent to each other in a predetermined direction and integrated.

FIGS. 7A and 7B are schematic arrangement explanatory diagrams of a collimator and a physical filter provided in the vicinity of an irradiation port of an X-ray irradiation unit in the X-ray inspection apparatus according to the second embodiment of the present invention, in which FIG. 7A is a top view of the collimator in the arrangement state, and FIG. 7B is a cross-sectional view taken along a line B7-B7 of FIG. 7A.

### BEST MODE FOR CARRYING OUT THE INVENTION

Hereinafter, modes for carrying out the present invention will be described with reference to the drawings.

### First Embodiment

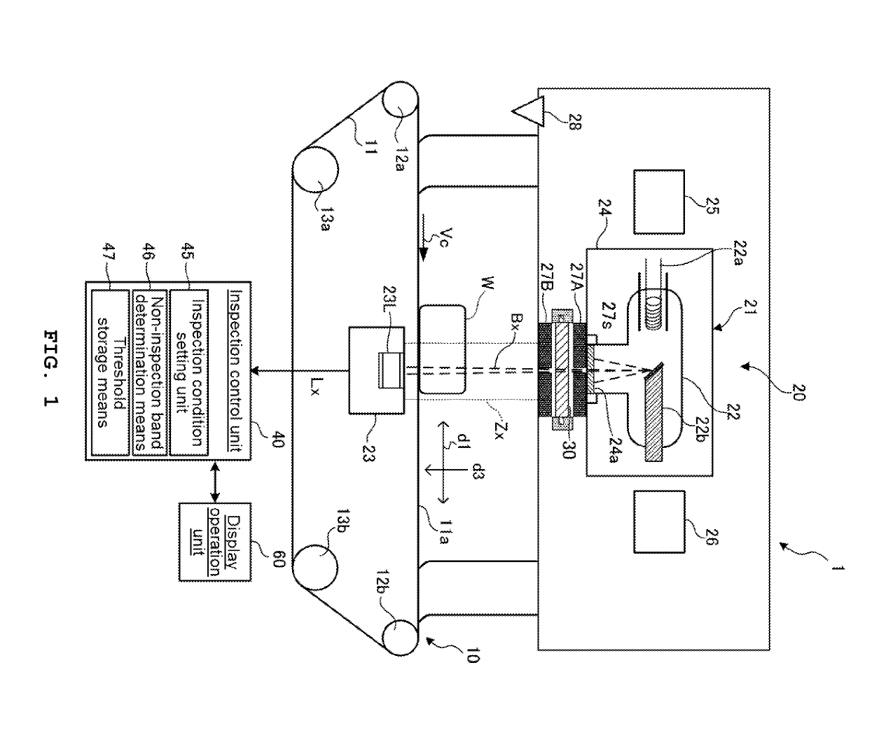

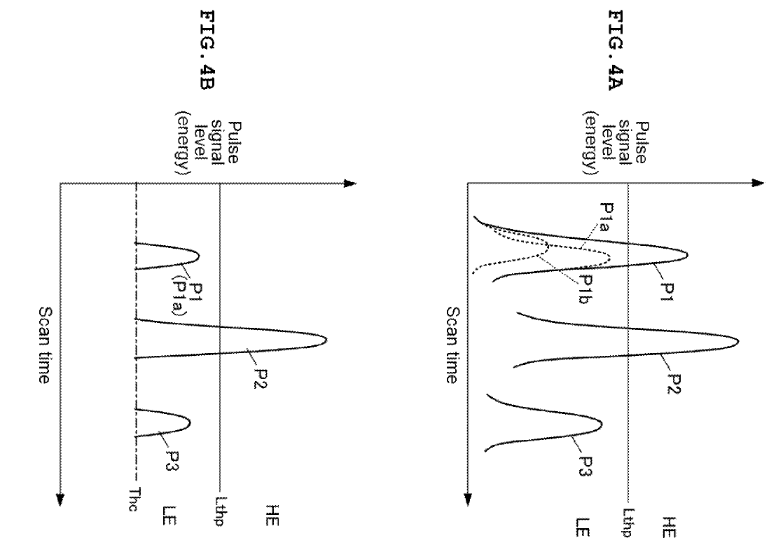

FIGS. 1-3B show an X-ray inspection apparatus according to a first embodiment of the present invention, and FIGS. 4A and 4B are explanatory diagrams of main functions thereof.

First, a configuration of the present embodiment will be described.

As shown in FIG. 1, an X-ray inspection apparatus 1 of the present embodiment includes a transport unit 10 that transports an article W that is an inspection object, an X-ray imaging unit 20 that performs X-ray imaging on the article W being transported and inspects the article W, an inspection control unit 40 that controls the transport unit 10 and the X-ray imaging unit 20, and a display operation unit 60 that is signal-connected to the inspection control unit 40 and is manually operable in the vicinity of the X-ray imaging unit 20.

The X-ray inspection apparatus 1 irradiates the article W transported by the transport unit 10 with X-rays via the X-ray imaging unit 20, generates image data corresponding to a transmitted X-ray amount distribution, and inspects a quality state of the article W based on the image data. The quality state mentioned herein is appropriateness and the like of a quality or a physical quantity required for the article W as a product, for example, the presence or absence of a contained foreign matter, the presence or absence of a missing product, the presence or absence of a defect in shape, size, storage state, or the like of contents, and a distribution of a density, a thickness, a volume, or a mass.

The transport unit 10 is a belt conveyor in which a loop-shaped transport belt 11 is wound around a plurality of parallel transport rollers 12a, 12b, 13a, and 13b, and is capable of sequentially transporting the article W on the transport belt 11 through an inspection region Zx in a predetermined transport direction (hereinafter, also referred to as a transport direction d1) indicated by an arrow d1 in FIG. 1. The transport unit 10 is supported by a housing (not shown).

The X-ray imaging unit 20 includes: an X-ray irradiation unit 21 (X-ray irradiation source) that incorporates an X-ray tube 22 and irradiates the inspection region Zx through which the article W passes with X-rays generated by the X-ray tube 22; and an X-ray detector 23 (X-ray detection unit) disposed at a predetermined position in the transport direction d1 to face the X-ray irradiation unit 21 with the inspection region Zx interposed therebetween, and is capable of performing X-ray imaging on the article W in the inspection region Zx.

The X-ray irradiation unit 21 includes a power supply and a drive circuit required to drive the X-ray tube 22 as an X-ray generation source, as well as cooling and X-ray shielding means for the X-ray tube 22, and causes the X-ray tube 22 to generate X-rays with wavelengths and intensities corresponding to a tube current and a tube voltage.

In addition, the X-ray irradiation unit 21 is capable of irradiating, in a vertical direction d3, the article W in the inspection region Zx on the transport belt 11 with, for example, fan-beam-shaped X-rays Bx that spread (or may be deflected) in a line scanning direction d2 orthogonal to the transport direction d1 of the transport unit 10, through a vacuum envelope of the X-ray tube 22 and an irradiation port 24a (irradiation window portion) of a tank 24 surrounding the vacuum envelope. The X-ray irradiation unit 21 uses either a fixed-type target (anode) or a rotating-type target.

The X-ray imaging unit 20 is provided with one drive power supply circuit 25 that applies a predetermined lighting voltage to a cathode 22a, and the other drive power supply circuit 26 that applies a positive potential corresponding to an operating anode voltage of a high voltage to an anode 22b, as drive circuits for the X-ray tube 22 of the X-ray irradiation unit 21. That is, the one drive power supply circuit 25 includes a so-called filament power supply circuit, and the other drive power supply circuit 26 includes a high-voltage circuit that applies a high voltage between a filament and a target of the X-ray tube 22.

The X-rays generated by the X-ray irradiation unit 21 are white X-rays having a continuous spectrum and including a plurality of different wavelength regions, and the energy of the X-rays needs to be set within a range suitable for inspection of the article W, and the tube voltage and the tube current applied to the X-ray tube 22 can be variably controlled by the inspection control unit 40. In addition, the X-rays emitted from the X-ray irradiation unit 21 and detected by the X-ray detector 23 are set to have predetermined radiation qualities (energy, wavelength) according to a product type of the article W.

In the present embodiment, particularly, so-called dual-energy or multi-energy X-ray images are generated by using a plurality of types of X-rays having different radiation qualities. Then, by performing difference processing on X-ray images having different energy bands (higher and lower), differential image data is generated in which image influence due to a difference in material (transmittance) between the article W and a foreign matter that can be contained therein is increased, thereby increasing detection sensitivity for abnormality such as a foreign matter contained therein.

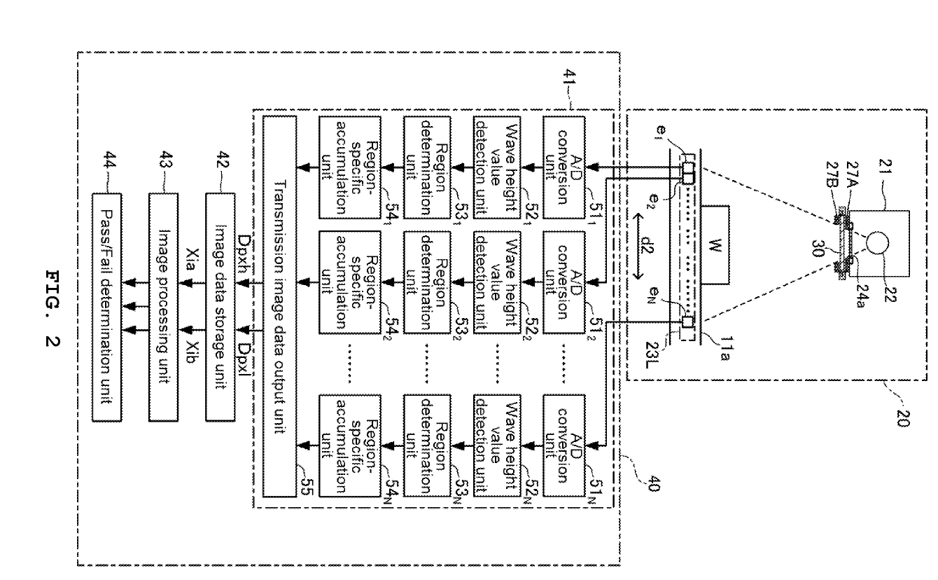

As shown in FIG. 2, the X-ray detector 23 includes a one-dimensional X-ray line sensor 23L in which a plurality of, for example, N (N is an integer greater than 1, for example, 256 × 8) sensor elements e1 to eN, each converting received X-rays into electrical signals, are arranged in a single row adjacent to one another in the line scanning direction d2. Although the X-ray detector 23 is exemplified herein as having a sensor array structure including the one-dimensional X-ray line sensor 23L, the X-ray detector 23 may include a two-dimensional X-ray line sensor. In addition, the X-ray detector 23 may be configured such that a predetermined number (k in FIG. 2) of sensor element modules M1 to Mk (k is any natural number, for example, 8) are arranged and joined in a single row in the line scanning direction, and, in such a case, each of the plurality of sensor element modules M1 to Mk may include, as each sensor element module Mi, a plurality of sensor elements e1 to em (m = N/k, for example, 256).

Specifically, the X-ray detector 23 is, for example, a photon detection type detector that uses a direct-conversion semiconductor element, such as a flat layered cadmium telluride (CdTe) semiconductor, as an X-ray conversion portion serving as each sensor element ei. The semiconductor element has opposing electrodes on both sides, one side serving as a bias electrode and the other side serving as an arrangement layer of a plurality of pixel electrodes corresponding to the plurality of sensor elements e1 to eN. Then, in each sensor element ei of the X-ray detector 23, when the X-rays from the X-ray irradiation unit 21 are incident on the semiconductor element, electrons and holes corresponding to an incident X-ray dose are generated between the opposing electrodes, and a pulse signal having a wave height corresponding to the energy of the X-rays (photons) can be output to the inspection control unit 40.

The inspection control unit 40 has a transport control function for controlling a transport speed Vc and a transport interval of the article W by the transport belt 11 in the transport unit 10, and an inspection control function for controlling an X-ray irradiation intensity and an irradiation period in the X-ray imaging unit 20 and controlling a scan cycle in the X-ray detector 23 and a detection period of each article W according to the transport speed Vc of the article W. Since a configuration of a transport control function unit is similar to a known configuration, the inspection control function will be described below.

Although a detailed overall configuration of the inspection control unit 40 is not shown, the inspection control unit 40 includes: a processor having a CPU, a ROM, a RAM, and an I/O interface (not shown); an auxiliary storage device that readably stores, in cooperation with the ROM, control programs for exerting an image processing function, an inspection determination function, and a control function thereof; and a hardware configuration including a timer circuit and the like, in which the hardware executes predetermined arithmetic processing while exchanging data between the CPU, the RAM, and the like in accordance with software such as a control program and setting information stored in the ROM or the like, and exerts various functions by executing the control program. The hardware referred to here may include a field programmable gate array (FPGA), a digital signal processor (DSP), or the like. In addition, the various functions referred to herein are functions of respective means for generating X-ray transmission image data, performing predetermined inspection control, and performing display output control.

### Inspection Control Unit

As shown in FIG. 2, the inspection control unit 40 includes an image data generation unit 41, an image data storage unit 42, an image processing unit 43, and a pass/fail determination unit 44 as an inspection control function unit.

Here, the image data generation unit 41 and the image data storage unit 42 are image generation units that generate a dual-energy or multi-energy X-ray image corresponding to the detection result of the X-ray detector 23, for example, dual-energy X-ray images Xia and Xib described below, based on the detection result of the X-rays by the X-ray detector 23. In addition, the image processing unit 43 and the pass/fail determination unit 44 are inspection processing units that inspect the article W based on the X-ray images Xia and Xib.

Specifically, the image data generation unit 41 sequentially captures, as image detection signals, X-ray detection signals for each predetermined scan cycle from the respective sensor elements ei of the X-ray detector 23, and generates image data of an X-ray image corresponding to a transmission amount distribution of the X-rays transmitted through the inspection region Zx. The image data generation unit 41 includes a plurality of A/D conversion units 51₁ to 51_{N} corresponding to the plurality of sensor elements e1 to eN, a plurality of wave height value detection units 52₁ to 52_{N}, a plurality of region determination units 53₁ to 53_{N}, a plurality of region-specific accumulation units 54₁ to 54_{N}, and a plurality of transmission image data output units 55.

The plurality of A/D conversion units 51₁ to 51_{N} capture, as an image detection signal Lx (see FIG. 1) of the X-ray detector 23, pulse signals having wave height corresponding to the energy of X-rays incident on the respective element regions from the plurality of sensor elements e1 to eN for each scan cycle (scan time) of the X-ray line sensor 23L, and A/D-convert the pulse signals into pulse signal levels indicating the respective pulse heights (energies).

For each scan cycle of the X-ray line sensor 23L, the plurality of wave height value detection units 52₁ to 52_{N} perform, for example, differentiation processing on a data sequence input from the A/D conversion units 51₁ to 51_{N}, detect a zero-cross timing at which a differential value (signal slope) switches from a positive value equal to or greater than a predetermined value to a negative value equal to or less than a predetermined value, detect a data value at the zero-cross timing as a wave height value of the pulse signal, and output the detected value to the region determination units 53₁ to 53_{N}.

The plurality of region determination units 53₁ to 53_{N} determine an energy band of X-rays incident on each element region of the plurality of sensor elements e1 to eN based on pulse signal levels detected by the corresponding wave height value detection units 52₁ to 52_{N}.

While capturing corresponding determination results from the plurality of region determination units 53₁ to 53_{N} as energy level values of X-rays incident on the plurality of sensor elements e1 to eN, the plurality of region-specific accumulation units 54₁ to 54_{N} execute processing of accumulating pulse signal level values by classifying the pulse signal level values into a plurality of different energy bands (higher and lower) during the scan time.

The number of accumulations herein is a cumulative number of pulse signals, among pulse signals output from each sensor element ei within the scan time, whose wave height values fall within the same energy band, and, by storing, in parallel and in time series, the accumulation numbers of the energy band output for each scan time in an image data memory, X-ray transmission image data for each element region corresponding to transmitted X-ray energy incident on each sensor element ei within the scan time can be obtained. In addition, in a case where the pulse signal level values are classified into two energy bands, that is, a high-energy band HE and a low-energy band LE, based on a predetermined threshold Lthp and the pulse signal levels of each energy band are accumulated, X-ray transmission image data Dpxh for the high-energy band HE and X-ray transmission image data Dpxl for the low-energy band LE can be generated.

Data obtained by accumulating the signal levels of the pulse signals from the plurality of sensor elements e1 to eN in the region-specific accumulation units 54₁ to 54_{N} in this manner are captured by the transmission image data output units 55 in association with the respective element regions of the plurality of sensor elements e1 to eN so as to obtain the X-ray transmission image data Dpxh and Dpxl based on the data.

The transmission image data output units 55 execute an operation of sequentially writing, into the image data storage unit 42, the region-specific accumulated data captured from the region-specific accumulation units 54₁ to 54_{N} in association with the element regions of the plurality of sensor elements e1 to eN.

The image data storage unit 42 accumulatively stores the image data Dpxh and Dpxl of X-ray images written by the transmission image data output units 55 of the image data generation unit 41 during a predetermined inspection period corresponding to a length of the article W in the transport direction, thereby generating and storing dual-energy imaging data of the article W. The image data storage unit 42 has a data processing program and an image memory region capable of exerting a function of generating, and outputting to the image processing unit 43, image data Xia and Xib of X-ray radiographic images corresponding to a dose distribution of the X-rays transmitted through the article W, as dual-energy imaging data of the article W, based on detection data of line-scan images sequentially written while line scanning by the X-ray line sensor 23L of the X-ray detector 23 is repeated a predetermined number of scans corresponding to an inspection period of the article W.

The image processing unit 43 executes predetermined filter processing (including preprocessing) capable of capturing the dual-energy imaging data Xia and Xib of the article W from the image data storage unit 42 and extracting each image feature, and image analysis processing such as measuring a feature amount of the extracted image feature. In the image processing unit 43, a predetermined inspection algorithm in which image processing filters and the like are combined is preset and stored in advance in order to execute predetermined article inspection based on the X-ray image data Xia and Xib captured from the image data storage unit 42.

The image processing filter included in the inspection algorithm of the image processing unit 43 is a processing program for extracting image features necessary for predetermined article inspection based on the X-ray image data Xia and Xib of the article W, and, when the inspection algorithm includes a filter for foreign matter detection, the image processing filter includes, for example, a feature extraction filter that performs edge detection processing of emphasizing an outline of a foreign matter in the article W, and emphasizes an edge of a foreign matter by performing differentiation processing or the like on a peripheral region of a pixel of interest. In addition, the feature measurement of image features executed by the image processing unit 43 is processing of measuring feature amounts required for determination processing in the pass/fail determination unit 44 by executing calculations regarding, for example, grayscale features, color features, shape features, and the like on an image obtained by applying necessary preprocessing and image processing to either the X-ray image data Xia and Xib of the article W captured from the image data storage unit 42 or differential image data thereof.

The pass/fail determination unit 44 is configured to execute determination processing of determining the presence or absence of a predetermined quality state of the article W based on data of the feature amount extracted by the image processing unit 43, for example, the presence or absence of a contained foreign matter, the presence or absence of a missing product, and the presence or absence of a defect in shape, size, storage state, or the like of contents. The pass/fail determination unit 44 executes processing of determining whether or not a local feature shape or the like corresponding to a foreign matter or a defective portion satisfying a determination condition is included in the article W by detecting the feature shape, the foreign matter, or the like detected in the article W or by comparing the feature amount such as an area, a contour length, and a concentration sum of the detection target with a predetermined determination reference value (hereinafter, referred to as a predetermined determination criterion), based on the feature amount extracted and measured by the image processing unit 43.

In this manner, the X-ray inspection apparatus 1 of the present embodiment irradiates the inspection region Zx into which the article W is carried in with X-rays Bx from the X-ray irradiation unit 21 of the X-ray imaging unit 20, detects X-rays transmitted through the inspection region Zx with the X-ray detector 23 having N sensor elements e1 to eN, generates imaging data Dpxh and Dpxl of the article W based on an image detection signal Lx of the X-ray detector 23, and executes, by the inspection control unit 40, inspection control for inspecting the article W using the image data and a predetermined determination criterion set in advance.

### Partial Cut of X-ray Irradiation Band

In the present embodiment, the X-ray tube 22 of the X-ray irradiation unit 21 serves as an X-ray generation source that outputs white X-rays having a continuous spectrum, and the X-ray irradiation unit 21 is detachably provided with a physical filter 30 that cuts, before irradiation, a partial band of the white X-rays generated and output by the X-ray tube 22, such that the physical filter 30 can be replaced according to the article W.

The physical filter 30 has a filter plate 31 that cuts X-rays in a portion of a low-energy band in the entire energy band of the white X-rays emitted from the X-ray irradiation unit 21, the low-energy band being included in a band LE on a lower-energy side than a predetermined threshold level Lthp as shown in FIG. 4A, in particular, X-rays in a low-energy band (long-wavelength band) low enough to be absorbed while being transmitted through the article W due to product influence of the article W.

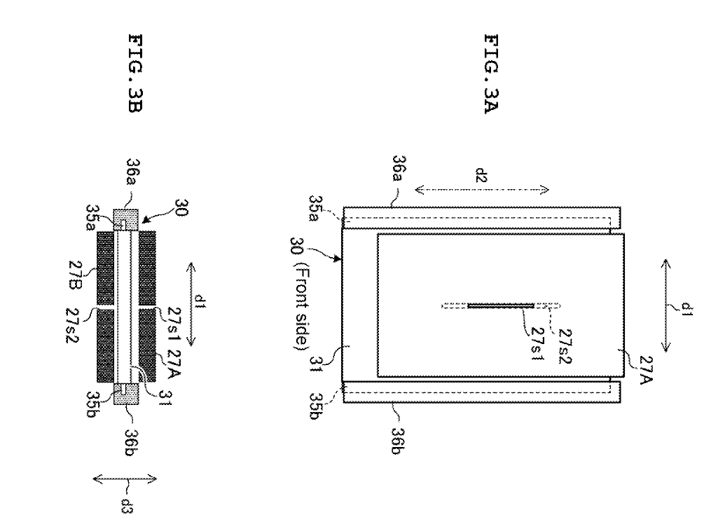

As shown in FIGS. 3A and 3B, left and right guide ribs 35a and 35b are provided at both side end portions of the filter plate 31 of the physical filter 30, and the guide ribs 35a and 35b are attached to left and right guide rails 36a and 36b so as to be slidable in a front-rear direction. Accordingly, the physical filter 30 is movable between a mounting position in the vicinity of the irradiation port 24a of the X-ray irradiation unit 21 (preferably, above a collimator) and an attachment/detachment position moved from the mounting position toward a front side or a rear side of the X-ray inspection apparatus 1. By preparing a plurality of types of physical filters having mutually different filter characteristics as the physical filter 30 and making the physical filters replaceable, the filter characteristic can be replaced and changed according to the article W and inspection contents thereof.

The material of the filter plate 31 of the physical filter 30 may be a material that is unlikely to deteriorate, and, for example, a metal such as aluminum, copper, or iron can be used. By changing a thickness and a material of the filter plate 31 by replacement, any unnecessary X-ray spectrum that does not effectively contribute to inspection can be cut.

In addition, in order to determine a spectrum band unnecessary for inspection, it is considered that the inspection control unit 40 is provided with an inspection condition setting unit 45 so as to determine, from an X-ray transmission image of the article W, an appropriate type and thickness of the physical filter, a tube voltage, a tube current, and a determination threshold as to whether photon counting is necessary in an energy band effective for inspection (hereinafter, also simply referred to as an energy threshold). In such a case, for example, a correlation between a count value and an energy threshold during X-ray irradiation onto the article W as an inspection object and execution of photon counting is obtained, an energy threshold immediately before count values of each article W start to decrease when the energy threshold is increased (a decrease in count values caused by changing the threshold begins) can be determined as a maximum energy of an unnecessary X-ray spectrum, and this value can be set as a non-inspection band determination threshold Thc (see FIG. 4B; hereinafter also simply referred to as a determination threshold Thc), which is a determination threshold as to whether an energy band is an energy band in which photon counting is performed, the determination threshold being used by the inspection condition setting unit 45, that is, a lower limit value of an energy band effective for inspection. The inspection condition setting unit 45 can also set the tube voltage and the tube current of the X-ray tube 22 of the X-ray irradiation unit 21 so as to set an upper limit value of an energy band effective for inspection and a required X-ray image density range.

In addition to the inspection condition setting unit 45, the inspection control unit 40 is provided with non-inspection band determination means 46 for determining, as an unnecessary spectrum, a partial band of white X-rays that is unnecessary for X-ray inspection of the article W by the determination threshold Thc. In accordance with a determination result of the non-inspection band determination means 46, the type of the physical filter 30 corresponding to the unnecessary spectrum and an insertion request therefor are displayed and output to the display operation unit 60 in a form such as a pop-up display, and a setting request related to filter setting and other inspection conditions by the inspection condition setting unit 45 can also be output.

Further, the inspection control unit 40 is provided with threshold storage means 47 for storing, for each product type of the article W, a determination threshold Thc as to whether an energy band is an energy band in which photon counting is performed (whether it is a non-inspection band). The non-inspection band determination means 46 selects and sets any one of the energy thresholds Thc stored in the threshold storage means 47 according to the product type of the article W, and the inspection condition setting unit 45, which is filter setting means, compares any one of the energy thresholds selected and set by the non-inspection band determination means 46 according to the product type of the article W with a cut state of an unnecessary spectrum by the physical filter 30 grasped by detecting, using the photon-counting method, X-rays transmitted through the physical filter 30, and determines whether or not an effective combination is achieved between an energy threshold to be set according to the product type of the article W and the physical filter 30 (whether it is a filter mounting state suitable for inspection). In a case where the combination is not achieved, the type of the physical filter 30 corresponding to the unnecessary spectrum is displayed and output on the display operation unit 60, and a setting request for filter setting and other inspection conditions by the inspection condition setting unit 45 is made possible.

More specifically, as a determination threshold as to whether an energy band is an energy band in which photon counting is performed, the physical filter 30 can set the material and thickness of the filter plate 31 so as to cut, for example, a relatively long-wavelength band within the low-energy band LE below the threshold level Lthp for determination of predetermined high and low energy bands in FIG. 4A, the relatively long-wavelength band having a pulse signal level (low energy) of half (1/2) or less of the predetermined threshold level Lthp.

As shown in FIGS. 1-3B, in an irradiation path of X-rays from the X-ray irradiation unit 21 to the X-ray detector 23, collimators 27A and 27B each formed of an X-ray shielding material are provided so as to limit an irradiation range of X-rays from the X-ray irradiation unit 21 to the vicinity of a detection range of the X-ray detector 23 and to prevent X-rays from leaking to the outside (outside the apparatus) of the X-ray inspection apparatus 1.

The collimators 27A and 27B shape an X-ray beam Bx from the X-ray irradiation unit 21 into a beam shape such as a cone shape or a fan shape by respective slits 27s1 and 27s2, thereby allowing X-rays that can be incident on the X-ray line sensor 23L of the X-ray detector 23 to pass through the X-ray irradiation region and blocking X-rays that reliably deviate from the detection region of the X-ray line sensor 23L.

In each of the drawings, the filter plate 31 of the physical filter 30 is disposed between the collimators 27A and 27B, and a mode is illustrated in which the left and right guide rails 36a and 36b serve as an X-ray shielding material, but the disposition is not limited to this. The collimators 27A and 27B may be only one, and the filter plate 31 of the physical filter 30 may be disposed on the X-ray irradiation unit 21 side of the collimator 27A.

In any arrangement, the X-ray detector 23 detects, using the photon-counting method, X-rays from which a band unnecessary for image generation in the image data generation unit 41 and the image data storage unit 42, which serve as an image generation unit, has been removed by the physical filter 30. Accordingly, when X-ray images Xia and Xib corresponding to an imaging result of the X-ray detector 23 are generated by the image data generation unit 41 and the image data storage unit 42 that constitute the image generation unit, X-rays incident on the X-ray detector 23 are such that a low-energy band low enough to be absorbed while being transmitted through the article W due to product influence of the article W is cut even in a range in which X-rays are not transmitted through the article W. Therefore, unnecessary pulse signals captured for each scan cycle of the X-ray line sensor 23L by the plurality of A/D conversion units 51₁ to 51_{N} of the image data generation unit 41 can be reduced without adversely affecting the imaging result. Thus, it is possible to prevent the plurality of wave height value detection units 52₁ to 52_{N} from performing wasteful wave height value detection processing for unnecessary pulse signals not effective for inspection.

On the other hand, for X-rays in an energy band effective for inspection that are transmitted through the article W and are detected by the X-ray detector 23, the plurality of region determination units 53₁ to 53_{N} can accurately determine transmitted X-ray energy bands based on pulse signal levels detected by the plurality of wave height value detection units 52₁ to 52_{N}.

In FIG. 1, the transport unit 10 is shown such that an upper running section 11a of the loop-shaped transport belt 11 is used as a transport path extending from an inlet to an outlet of the X-ray inspection apparatus 1 for the article W, but the transport belt 11 may be divided into an upstream side and a downstream side in the article transport direction with an irradiation position of the X-ray beam Bx from the X-ray irradiation unit 21 to the X-ray detector 23 interposed therebetween, and the X-ray beam Bx from the X-ray irradiation unit 21 may be incident on the X-ray detector 23 between the upstream and downstream transport belts. In addition, in this case, it is considered to reduce thermal influence or the like due to direct irradiation by using a polyimide film or the like as a resin cover on an upper surface of the X-ray detector 23 on which the X-rays are incident.

Next, operations will be described.

In the X-ray inspection apparatus of the present embodiment configured as described above, among X-rays emitted from the X-ray irradiation unit 21, X-rays in a spectrum band unnecessary for inspection in the inspection control unit 40, for example, X-rays in a low-energy band that are absorbed by the article W and do not reach the X-ray detector 23, are prevented from being photon-counted even in a range where the X-rays are not transmitted through the article W or in a thin portion of the article W; therefore, it is possible to effectively suppress an increase in X-ray flux incident on the X-ray detector 23.

As a result, in the related art, a pile-up phenomenon occurs in which, as in a leftmost pulse signal P1 among a plurality of pulse signals P1, P2, and P3 in FIG. 4A, signal levels of two pulse signals P1a and P1b within a low-energy band LE counted at close timings are counted together and are grasped as a pulse signal P1 in a high-energy band HE. On the other hand, in the present embodiment, in the low-energy band LE in which X-ray flux incident on the X-ray detector 23 tends to increase, photon counts at approximately a signal level of the pulse signal P1b are not counted together. Therefore, as shown in FIG. 4B, occurrence of the pile-up phenomenon can be effectively suppressed.

In addition, in the present embodiment, since the physical filter 30 is replaceably provided in the vicinity of the irradiation port 24a of the X-ray irradiation unit 21, it is possible to effectively prevent X-rays in an unnecessary spectrum band from being emitted from the X-ray irradiation unit 21, and to replace the physical filter 30 according to the product type of the article W and a degree of product influence thereof.

Moreover, in the present embodiment, since the X-ray inspection apparatus includes: the non-inspection band determination means 46 for determining, as an unnecessary spectrum, a partial band of white X-rays that is unnecessary for X-ray inspection of the article W by the inspection control unit 40; and the inspection condition setting unit 45 as filter setting means for switchably setting a physical filter corresponding to the unnecessary spectrum according to a determination result of the non-inspection band determination means 46, when a partial band unnecessary for inspection of the article W is determined as the unnecessary spectrum by the non-inspection band determination means 46, the physical filter 30 corresponding to the unnecessary spectrum can be appropriately set by detachably replacing the physical filter 30 according to the determination result.

In addition, in the present embodiment, the non-inspection band determination means 46 sets an energy threshold Thc for determining the X-rays detected by the photon-counting method as the unnecessary spectrum, and mounts the physical filter 30 corresponding to the set value Thc. The energy threshold Thc is set, under a state where X-rays emitted from the X-ray irradiation unit 21 and transmitted through a non-defective article W or a master piece substituting therefor are detected by the X-ray detector 23, by varying, for example, increasing, an energy threshold for determining an unnecessary spectrum to a plurality of different values within a predetermined variable range, and determining, as a maximum energy of an unnecessary X-ray spectrum, a threshold immediately before a decrease in count values caused by increasing the threshold begins, thereby setting the threshold to the threshold Thc at which the number of count values determined as the unnecessary spectrum is maximized. Accordingly, since the energy threshold Thc for determining an unnecessary spectrum most suppresses influence of the article W, it is suitable for foreign matter detection.

Further, in the present embodiment, the threshold storage means 47 for storing an energy threshold Thc for each product type of the article W is provided. The non-inspection band determination means 46 selects and sets any one of the energy thresholds stored in the threshold storage means 47 according to the product type of the article W, and the inspection condition setting unit 45, which is filter setting means, can determine, at the time of switching the article W to another product type, whether or not the physical filter 30 corresponding to the new product type is mounted, and can display and output, to the display operation unit 60, that it is necessary to change inspection conditions. Therefore, selection and setting of an energy threshold Thc according to the product type of the article W and the corresponding physical filter 30 can be set to conditions more effective for X-ray inspection of the article W.

### Second Embodiment

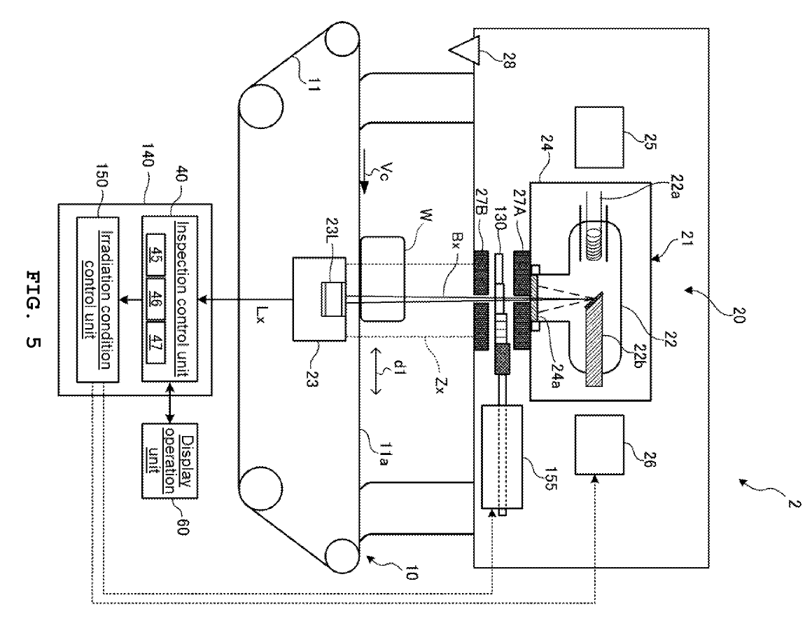

FIGS. 5-7B show an X-ray inspection apparatus 2 according to a second embodiment of the present invention.

Since the present embodiment has the same or similar configurations as those of the first embodiment, redundant description of those same or similar configurations and operations is omitted by using, in FIGS. 5-7B, reference signs of corresponding constituent elements shown in FIGS. 1-3B, and differences will be described below.

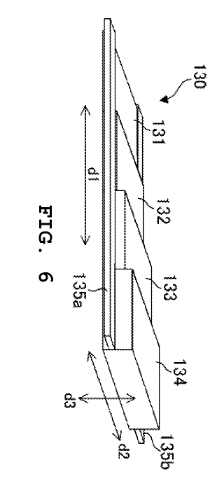

As shown in FIGS. 5 and 6, in the present embodiment, the X-ray irradiation unit 21 of the X-ray imaging unit 20 is detachably provided with a physical filter 130 that cuts a partial band of white X-rays generated and output by the X-ray tube 22.

The physical filter 130 has a plurality of types, for example, four types, of filter plates 131, 132, 133, and 134 (see FIG. 6) that cut, into different partial bands, X-rays in a portion of a low-energy band included in a band LE on a lower-energy side than a predetermined threshold level Lthp, in particular, X-rays in a relatively long-wavelength band that becomes a low-energy band low enough to be absorbed while being transmitted through the article W due to product influence of the article W, when the entire energy band of white X-rays emitted from the X-ray irradiation unit 21 is divided, similarly to the physical filter 30 of the first embodiment, into the band HE on the higher-energy side than the predetermined threshold level Lthp and the band LE on the lower-energy side than the predetermined threshold level Lthp as shown in FIG. 4A.

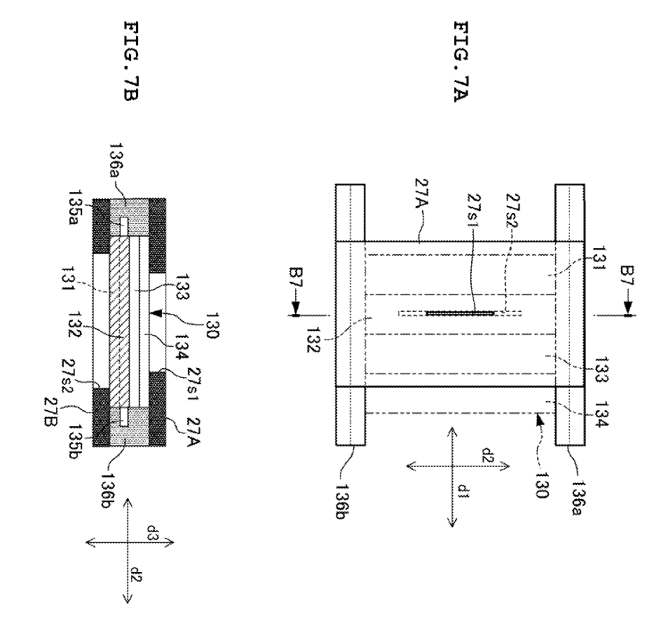

As shown in FIGS. 6, 7A, and 7B, a pair of guide ribs 135a and 135b are provided at both end portions of the filter plates 131 to 134, the guide ribs 135a and 135b protruding to both sides in the line scanning direction d2 and extending in the transport direction d1. The guide ribs 135a and 135b are supported by a pair of front and rear guide rails 136a and 136b so as to be reciprocally slidable in a direction parallel to the transport direction d1. Accordingly, the physical filter 130 is movable such that any one of the filter plates 131 to 134 can be moved between a mounting position in the vicinity of the irradiation port 24a of the X-ray irradiation unit 21 and a retracted position separated from the mounting position by a predetermined distance in the transport direction, and filter characteristics can be automatically switched according to the article W and inspection contents thereof by preparing a plurality of types of filter plates 131 to 134 having different filter characteristics.

Materials of the plurality of types of filter plates 131 to 134 can be selected as appropriate according to the article W and inspection contents thereof, and are not particularly limited. By way of example, a material of the filter plate 131 shown in FIG. 6 is, for example, an aluminum plate having a predetermined plate thickness, a material of the filter plate 132 is, for example, an aluminum plate having a plate thickness larger than that of the filter plate 131, a material of the filter plate 133 is, for example, an iron plate having a plate thickness larger than that of the filter plate 132, and a material of the filter plate 134 is, for example, a copper plate having a plate thickness larger than that of the filter plate 133.

In the present embodiment, in order to determine a spectrum band unnecessary for inspection, a control unit 140 that captures an image detection signal Lx from the X-ray detector 23 is provided with the inspection control unit 40 similar to that of the first embodiment, and the inspection control unit 40 includes the inspection condition setting unit 45, the non-inspection band determination means 46, and the threshold storage means 47. The control unit 140 includes hardware and software similar to the inspection control unit 40 of the first embodiment, but further includes the following configuration in order to variably control the irradiation condition of the X-ray irradiation unit 21.

That is, the control unit 140 is provided with an irradiation condition control unit 150 in addition to the inspection control unit 40 as in the first embodiment. The irradiation condition control unit 150 variably sets, based on a control output of the inspection control unit 40, a determination threshold Thc (non-inspection band determination threshold) determined by the non-inspection band determination means 46 according to the product type of the article W, a type of any one of the filter plates 131 to 134 of the physical filter 130 suitable for the determination threshold Thc, and a tube voltage, a tube current, and the like of the X-ray tube 22 of the X-ray irradiation unit 21.

Specifically, the irradiation condition control unit 150 serves as a functional unit that determines, from an X-ray transmission image of the article W, an appropriate type and thickness of the physical filter, a tube voltage, a tube current, and an energy threshold as to whether photon counting is necessary, and has hardware and software corresponding to the function.

For example, the irradiation condition control unit 150 obtains a correlation between a count value and an energy threshold during X-ray irradiation onto the article W and execution of photon counting, determines an energy threshold immediately before count values of each article W start to decrease when the energy threshold is increased (a decrease in count values caused by changing the threshold begins) as a maximum energy of an unnecessary X-ray spectrum, sets the threshold as a determination threshold Thc serving as a determination threshold (a lower limit value of an energy band effective for inspection) as to whether an energy band is an energy band in which photon counting is performed, the determination threshold being used by the inspection condition setting unit 45, and enables selection of any one of the filter plates 131 to 134 of the physical filter 130 suitable for the determination threshold Thc.

In addition, the irradiation condition control unit 150 can control a tube voltage and a tube current of the X-ray tube 22 of the X-ray irradiation unit 21 by controlling the one drive power supply circuit 25 and the other drive power supply circuit 26 of the X-ray imaging unit 20, and can position any one of the filter plates 131 to 134 of the physical filter 130 at a mounting position in the vicinity of the irradiation port 24a of the X-ray irradiation unit 21 via a linear motion actuator 155 such as a direct-acting stepping motor (which may include a mechanism for converting rotary motion into linear motion). Note that functions of the inspection condition setting unit 45, the non-inspection band determination means 46, and the threshold storage means 47 in the inspection control unit 40 are as described above.

In the present embodiment as well, similarly to the first embodiment, among X-rays emitted from the X-ray irradiation unit 21, X-rays in a spectrum band unnecessary for inspection in the inspection control unit 40, for example, X-rays in a low-energy band that are absorbed by the article W and do not reach the X-ray detector 23, are prevented from being photon-counted even in a range where the X-rays are not transmitted through the article W or in a thin portion of the article W; therefore, it is possible to effectively suppress an increase in X-ray flux incident on the X-ray detector 23.

As a result, in the related art, a pile-up phenomenon occurs in which, as in a leftmost pulse signal P1 in FIG. 4A as described for the first embodiment, signal levels of two pulse signals P1a and P1b within a low-energy band LE counted at close timings are counted together and are grasped as a pulse signal P1 in a high-energy band HE. On the other hand, in the present embodiment, since a signal level of the pulse signal P1b is approximately equal to or lower than the energy threshold Thc according to the product type of the article W, the pulse signal P1b is not counted together with the pulse signal P1a, so that the pile-up phenomenon can be effectively suppressed as shown in FIG. 4B.

In addition, in the present embodiment, the control unit 140 operates the inspection condition setting unit 45 as filter setting means for switchably setting a physical filter corresponding to an unnecessary spectrum according to a determination result of the non-inspection band determination means 46 of the inspection control unit 40. Therefore, when a partial band unnecessary for inspection of the article W is determined as an unnecessary spectrum by the non-inspection band determination means 46, the irradiation condition control unit 150 is operated according to the determination result, any one of the plurality of types of filter plates 131 to 134 of the physical filter 130 corresponding to the unnecessary spectrum is automatically selected, and the selected filter plate can be positioned and disposed at a mounting position in the vicinity of the irradiation port 24a of the X-ray irradiation unit 21 via the linear motion actuator 155.

Accordingly, selection and setting of the physical filter 130 corresponding to an unnecessary spectrum according to the product type of the article W becomes possible. Thus, regardless of the product type of the article W, by cutting a partial band serving as an unnecessary spectrum, it is possible to effectively suppress an increase in X-ray flux incident on the X-ray detector 23 during photon-counting type X-ray detection, and it is possible to effectively suppress occurrence of pile-up during photon counting.

As a result, it is possible to provide the X-ray inspection apparatus 2 that is excellent in discrimination performance of X-ray transmission energy and that can sufficiently increase foreign matter detection accuracy even when a high dose of X-rays is emitted by the X-ray irradiation unit 21.

It is needless to say that shapes and sizes of the collimators 27A and 27B and the filters 30 and 130 exemplified in the above embodiments, the number of the plurality of types of filter elements, and the like are all arbitrary.

As described above, the present invention can provide an X-ray inspection apparatus that is excellent in discrimination performance of X-ray transmission energy even with a high dose of X-rays and that can sufficiently increase foreign matter detection accuracy, and the present invention is useful for general X-ray inspection apparatuses that irradiate a transported article with X-rays and inspect the article based on an X-ray transmission image.

Description of Reference Numerals and Signs
1; 2 X-ray inspection apparatus
10 Transport unit
11 Transport belt
11a Upper running section
12a, 12b, 13a, 13b Transport roller
20 X-ray imaging unit
21 X-ray irradiation unit (X-ray irradiation source)
22 X-ray tube (X-ray generator)
22a Cathode
22b Anode
23 X-ray detector (X-ray detection unit)
23L X-ray line sensor
24 Tank
24a Irradiation port (irradiation window portion)
25 One drive power supply circuit (cathode side drive power supply circuit)
26 Other drive power supply circuit (anode side drive power supply circuit)
27A, 27B Collimator
27s1, 27s2 Slit
30 Physical filter
31 Filter plate (filter element)
35a, 35b Guide rib
36a, 36b Guide rail
40 Inspection control unit
41 Image data generation unit
42 Image data storage unit
43 Image processing unit
44 Pass/fail determination unit
45 Inspection condition setting unit (filter setting means)
46 Non-inspection band determination means
47 Threshold storage means
51₁ to 51_{N} A/D conversion unit
52₁ to 52_{N} Wave height value detection unit
53₁ to 53_{N} Region determination unit
54₁ to 54_{N} Region-specific accumulation unit
55 Transmission image data output unit
60 Display operation unit
130 Physical filter
131, 132, 133, 134 Filter plate (filter element)
135a, 135b Guide rib
136a, 136b Guide rail
140 Control unit
150 Irradiation condition control unit
155 Linear motion actuator
d1 Transport Direction
d2 Line Scanning Direction
d3 Vertical direction
Dpxh, Dpxl X-ray transmission image data (imaging data, image data)
e1 to eN Sensor element
HE Energy band on higher-energy side
LE Energy band on lower-energy side
P1 Pulse signal
P1a, P1b Pulse signal
Thc Determination threshold (energy threshold, non-inspection band determination threshold)
Xia, Xib X-ray image data (image data)
W Article

What is claimed is:

1. An X-ray inspection apparatus comprising:
an X-ray irradiation unit that irradiates a transported article with X-rays;
an X-ray detection unit that detects the X-rays transmitted through the article using a photon-counting method;
an image generation unit that generates an X-ray image corresponding to a detection result of the X-ray detection unit; and
an inspection processing unit that inspects the article based on the X-ray image,
wherein the X-ray irradiation unit includes an X-ray generation source that outputs white X-rays having a continuous spectrum, and a physical filter that removes a partial band of the white X-rays output by the X-ray generation source to irradiate the article with resulting X-rays from which a partial band of the white X-rays has been removed, the physical filter being provided between the X-ray generation source and the X-ray detection unit, and
the X-ray detection unit detects, using the photon-counting method, the X-rays transmitted through the article, the X-rays being X-rays from which a band unnecessary for image generation in the image generation unit has been removed by the physical filter.

2. The X-ray inspection apparatus according to claim 1,
wherein the physical filter is replaceably provided in the vicinity of an irradiation port of the X-ray irradiation unit.

3. The X-ray inspection apparatus according to claim 1, further comprising:
non-inspection band determination means for determining, as an unnecessary spectrum, a partial band of the white X-rays that is unnecessary for inspection of the article in the inspection processing unit; and
filter setting means for switchably setting a physical filter corresponding to the unnecessary spectrum according to a determination result of the non-inspection band determination means.

4. The X-ray inspection apparatus according to claim 3,
wherein the non-inspection band determination means determines, as the unnecessary spectrum, a band lower than an energy threshold at which the number of count values determined as the unnecessary spectrum is maximized when an energy threshold for determining the unnecessary spectrum is changed to a plurality of different values within a predetermined variable range in a state where X-rays emitted from the X-ray irradiation unit and transmitted through a non-defective article are detected by the X-ray detection unit.

5. The X-ray inspection apparatus according to claim 4,
wherein threshold storage means for storing the energy threshold for each product type of the article is provided,
the non-inspection band determination means selects and sets any one of the energy thresholds stored in the threshold storage means according to the product type of the article, and
the filter setting means selects and sets a physical filter corresponding to any one of the energy thresholds selected and set by the non-inspection band determination means according to the product type of the article.

6. The X-ray inspection apparatus according to claim 3,
wherein the filter setting means has, as the physical filter, a plurality of filter elements having different materials and thicknesses in an X-ray transmission direction, the plurality of filter elements being displaceable in a predetermined direction, and is configured to enable replacement, in the vicinity of an irradiation port of the X-ray irradiation unit, of any one of the plurality of filter elements according to the product type of the article.

7. The X-ray inspection apparatus according to claim 2, further comprising:
non-inspection band determination means for determining, as an unnecessary spectrum, a partial band of the white X-rays that is unnecessary for inspection of the article in the inspection processing unit; and
filter setting means for switchably setting a physical filter corresponding to the unnecessary spectrum according to a determination result of the non-inspection band determination means.

8. The X-ray inspection apparatus according to claim 7,
wherein the non-inspection band determination means determines, as the unnecessary spectrum, a band lower than an energy threshold at which the number of count values determined as the unnecessary spectrum is maximized when an energy threshold for determining the unnecessary spectrum is changed to a plurality of different values within a predetermined variable range in a state where X-rays emitted from the X-ray irradiation unit and transmitted through a non-defective article are detected by the X-ray detection unit.

9. The X-ray inspection apparatus according to claim 8,
wherein threshold storage means for storing the energy threshold for each product type of the article is provided,
the non-inspection band determination means selects and sets any one of the energy thresholds stored in the threshold storage means according to the product type of the article, and
the filter setting means selects and sets a physical filter corresponding to any one of the energy thresholds selected and set by the non-inspection band determination means according to the product type of the article.

10. The X-ray inspection apparatus according to claim 7,
wherein the filter setting means has, as the physical filter, a plurality of filter elements having different materials and thicknesses in an X-ray transmission direction, the plurality of filter elements being displaceable in a predetermined direction, and is configured to enable replacement, in the vicinity of an irradiation port of the X-ray irradiation unit, of any one of the plurality of filter elements according to the product type of the article.
